(19) United States
(12) Patent Application Publication
(10) Pub. No.: US 2026/0138752 A1
(43) Pub. Date: May 21, 2026

(54) PROPULSION UNIT

(71) Applicants: HYUNDAI MOTOR COMPANY, Seoul (KR); KIA CORPORATION, Seoul (KR)

(72) Inventors: Kam Chun LEE, Hwaseong-si (KR); Kwon Su SHIN, Hwaseong-si (KR); Jeong Uk AN, Hwaseong-si (KR); Ki Tack LIM, Hwaseong-si (KR); Yong Sok JANG, Hwaseong-si (KR); Kyung Ku YEO, Hwaseong-si (KR); Chee Mann KIM, Hwaseong-si (KR); Kyung Jun LEE, Hwaseong-si (KR); Hyun Woo JUN, Hwaseong-si (KR); Sung Ho LEE, Hwaseong-si (KR); Jae Joon LEE, Hwaseong-si (KR); Hoan Ju YOO, Hwaseong-si (KR); Dong Su LEE, Hwaseong-si (KR); Yun Kyung HWANG, Hwaseong-si (KR); Jong Hun CHOI, Hwaseong-si (KR); Hong Wook LEE, Hwaseong-si (KR); Jae Young JEUN, Hwaseong-si (KR)

(21) Appl. No.: 19/381,625

(22) Filed: Nov. 6, 2025

(30) Foreign Application Priority Data
Nov. 19, 2024 (KR) 10-2024-0164710

(51) Int. Cl. B64D 33/08; H02K 9/19; H02K 11/33

(52) U.S. Cl. CPC B64D 33/08; H02K 9/19; H02K 11/33

(57) ABSTRACT

A propulsion unit includes a stator, a rotor configured to rotate relative to the stator, an inverter electrically connected to the stator, and a cooling housing through which coolant flows inside. The cooling housing is in contact with the stator and the inverter.

### CROSS-REFERENCE TO RELATED APPLICATION

This application claims priority to and the benefit of Korean Patent Application No. 10-2024-0164710, filed on Nov. 19, 2024, the disclosure of which is incorporated herein by reference in its entirety.

### TECHNICAL FIELD

The present disclosure relates to a propulsion unit.

### BACKGROUND

A mobility apparatus refers to a means of transportation that can transport people or cargo in the sky over a city by flying using a propulsion unit. For example, the propulsion unit of the mobility apparatus may include a propeller and a driving unit for rotating the propeller, and the driving unit may include a motor and an inverter for supplying power to the motor.

The motor may include a stator and a rotor, where the rotor may be connected to a shaft, and the shaft may be connected to the propeller. The rotor may be rotated by electromagnetic interaction with the stator, and the shaft and the propeller may rotate as the rotor rotates.

In some cases, since the motor may have a relatively small internal space, the inverter may be separately provided and assembled to the motor. In some cases, where the inverter is provided separately, the size of the propulsion unit may increase.

In some cases, where the motor and the inverter are spaced apart from each other, a path connecting the motor to the inverter may increase. In some cases, a separate cooling unit in addition to a cooling unit of the motor may be provided to cool the inverter, which may result in complexity of the propulsion unit and an increase of the size of the propulsion unit.

### SUMMARY

The present disclosure is directed to providing a propulsion unit that can reduce a size of the propulsion unit and perform cooling on an inverter.

According to one aspect of the subject matter described in this application, a propulsion unit includes a stator, a rotor configured to rotate relative to the stator, an inverter electrically connected to the stator, and a cooling housing that is in contact with the stator and the inverter and configured to carry coolant therein.

Implementations according to this aspect can include one or more of the following features. For example, the cooling housing can have an outer surface and an inner surface, where the inverter is in contact with one of the outer surface or the inner surface of the cooling housing, and the stator is in contact with the other of the outer surface or the inner surface of the cooling housing.

In some implementations, the inverter can be positioned between a shaft of the rotor and the stator in a radial direction of the rotor, and the cooling housing can be positioned between the stator and the inverter in the radial direction. In some implementations, the cooling housing can define a cooling channel configured to carry the coolant, the cooling channel being positioned adjacent to the stator and the inverter.

In some examples, the cooling housing can include a plurality of fins that protrude from an inner wall of the cooling channel. In some implementations, the plurality of fins can be disposed at each of a plurality of first regions of the cooling channel, the plurality of first regions being spaced apart from one another in a circumferential direction of the cooling housing. In some examples, the inverter has at least one element that is in contact with the cooling housing. For instance, the at least one element of the inverter is in contact with a part of the cooling housing corresponding to one of the plurality of first regions.

In some implementations, the cooling channel can be arranged in a plurality of rows that extend in an axial direction, where the plurality of fins can be disposed in at least two of the plurality of rows of the cooling channel. In some implementations, the cooling channel has the inner wall and an outer wall that face each other in a radial direction of the cooling housing, where the plurality of fins protrude from the inner wall toward the outer wall.

In some implementations, the cooling housing can include a hub, a rim portion disposed outside the hub, and an arm portion connecting the hub to the rim portion, where the cooling channel is disposed at the rim portion. In some examples, the inverter can include a board and an element electrically connected to the board, the element having (i) a first side that is in contact with the rim portion and (ii) a second side connected to the board of the inverter. In some examples, the inverter can include at least one element fixed to an inner surface of the rim portion.

In some implementations, the propulsion unit can further include a heat transfer pad disposed between an element of the inverter and the cooling housing and configured to transfer heat generated from the element to the cooling housing.

In some implementations, the inverter can include a substrate, an element spaced apart from the substrate, and a connection terminal that connects the element to the substrate. In some implementations, the inverter can include an element that overlaps the cooling channel in a radial direction of the cooling housing.

In some implementations, the inverter can be one of a first inverter and a second inverter that are electrically separated from each other and configured to operate independently. In some examples, each of the first inverter and the second inverter can include at least one element in contact with the cooling housing.

In some implementations, the first inverter and the second inverter can be disposed symmetrically with respect to a reference line passing through a rotation center axis of the rotor, the first inverter being disposed at a first side of the reference line, and the second inverter being disposed at a second side of the reference line.

### BRIEF DESCRIPTION OF THE DRAWINGS

The above and other objects, features and advantages of the present disclosure will become more apparent to those of ordinary skill in the art by describing example implementations thereof in detail with reference to the accompanying drawings.

FIG. 1 is a schematic view illustrating example modules of a mobility apparatus.

FIG. 2 is a view illustrating an example of a mobility apparatus.

FIG. 3 is a side cross-sectional view illustrating an example of a propulsion unit of the mobility apparatus.

FIG. 4 is a view illustrating an example of a cooling housing.

FIG. 5 is a view illustrating the cooling housing in which an inverter is disposed.

FIG. 6 is a block diagram illustrating an example of a first inverter and a second inverter.

FIG. 7 is a plan view illustrating example elements of the inverter fixed to the cooling housing.

FIG. 8 is a side cross-sectional view illustrating the elements fixed to the cooling housing.

FIG. 9 is a side cross-sectional view illustrating a process of dissipating heat through fins;

FIG. 10 is a plan cross-sectional view illustrating the process of dissipating heat through the fins; and

FIG. 11 is a side cross-sectional view illustrating positions of the inverter and a motor.

### DETAILED DESCRIPTION

Since the present disclosure can have various changes and various implementations, specific implementations are illustrated and described in the accompanying drawings. However, it should be understood that it is not intended to limit specific implementations, and it should be understood to include all modifications, equivalents, and substitutes included in the spirit and scope of the present disclosure.

Hereinafter, implementations will be described in detail with reference to the accompanying drawings, and the same or corresponding components are denoted by the same reference numeral regardless of the reference numerals, and overlapping descriptions thereof will be omitted.

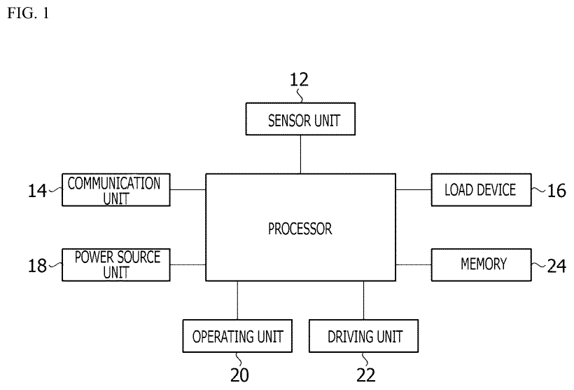

Hereinafter, FIG. 1 is a schematic view illustrating example modules of a mobility apparatus.

In some implementations, a mobility apparatus 10 can be a mobile apparatus having mobility. For example, the mobility apparatus 10 can load people, objects for a specific purpose, and/or cargo while moving from one point to a specific point. That is, the mobility apparatus 10 can move for transportation and other purposes, and the other purposes can include, for example, mounting an observation device to detect or monitor a surrounding environment of the mobility apparatus 10. More specifically, the mobility apparatus 10 can be provided with a camera to capture or analyze images of surrounding environments and transmit the captured or analyzed images to a predetermined device. The mobility apparatus 10 is not limited to the above example and can be used for various purposes.

Depending on space in which the mobility apparatus 10 moves, the mobility apparatus 10 can move in space related to the ground, underground, air, space, sea, and/or underwater. The mobility apparatus 10 for a ground or underground can be provided in the form of, for example, a vehicle, a robot, or the like, and the mobility apparatus 10 for air or space can be an aerial mobility apparatus and, for example, provided in the form of a conventional fixed-wing or rotary-wing aircraft, an advanced air mobility (AAM) that has been actively developed recently, an unmanned aircraft or drone, a rocket, a means of transportation mounted on an artificial satellite, or the like. The mobility apparatus 10 for sea or underwater can be, for example, a ship, a submarine, or the like. The mobility apparatus 10 can be a moving apparatus that is not limited to a specific space and can move in all of the above spaces, that is, a moving apparatus that can move to a plurality of spaces and, for example, can be an amphibious vehicle, a flying vehicle, or the like.

In addition, the mobility apparatus 10 can be moved through a manual operation, autonomy control, or a combination thereof. The manual operation can be implemented by a driver or an operator through an interface such as a control device provided on the mobility apparatus 10 or implemented by remote control by a control center or an external control center. The autonomy control, that is, autonomous movement, can be performed by independent processing of the mobility apparatus 10 or performed by a combination of remote control via the control center and collaborative processing of the mobility apparatus 10 with the control center or the like.

In some implementations, the mobility apparatus 10 operated in various forms can be designed differently depending on a purpose, a movement space, a driving method, a control method, or the like, but can have common function modules as illustrated in FIG. 1 from a comprehensive perspective such as mobility. FIG. 1 mainly describes common functions of any type of mobility apparatus 10. Accordingly, although a unique function module used in each type is omitted, it is apparent that an implementation of the present disclosure does not exclude modules in which the mobility apparatus 10 is omitted in FIG. 1, and the modules are not excluded from the scope of the present implementation.

The mobility apparatus 10 can include a sensor unit 12, a communication unit 14, and a load device 16.

The sensor unit 12 can have any type of detector for detecting various states and situations occurring in external and internal environments of the mobility apparatus 10 and identifying position information of the mobility apparatus 10. That is, the sensor unit 12 can include different types of sensors and acquire sensing data detected from each sensor. The sensor unit 12 can acquire sensor data used for movement control, state data on detected states of modules constituting the mobility apparatus 10, situation data on detected situations of passengers and/or loads, and the like and provide the acquired data to a processor 26 for triggering a predetermined function and operation. In the present disclosure, the movement control can be at least one piece of operation control related to linear movement, turning, acceleration/deceleration, attitude control, braking, and hovering of the mobility apparatus 10, or the like. In the present disclosure, the hovering can be performing control so that the thrust is generated downward from or perpendicular to the mobility apparatus 10 to trigger the predetermined operation or movement of the mobility apparatus 10. The predetermined operation or movement can be, for example, takeoff, landing, or a substantially stationary flight within a limited range. The above data of the sensor unit 12 is merely illustrative and can additionally include sensor data on various detected situations not listed herein.

The communication unit 14 can support mutual communication with other devices to exchange data with other external devices. The other devices can be, for example, a server for controlling the mobility apparatus 10 or exchanging data related to the movement control of the mobility apparatus 10, an auxiliary device for supporting movement, another mobility apparatus, and the like. The server can be referred to as various terms, such as a control device, a management device, a control device, and the like. The communication unit 14 can transmit data generated or stored during movement to another device and receive data and software modules transmitted from another device. A protocol applied to the communication unit 14 can be determined according to the type of the mobility apparatus 10, and, for example, can communicate with another vehicle or another device based on cellular communication, wireless access in vehicular environment (WAVE) communication, dedicated short range communication (DSRC) or short-range communication, or other communication methods. The communication protocols and methods listed above are illustrative and are not limited thereto.

The load device 16 can be an auxiliary device that is mounted on the mobility apparatus 10 to consume power that is supplied from a power source unit 18 by a command for a user's usage or management of the load or converted from the output of the power source unit 18. The load device 16 can be a type of non-mobile electric device not including a mobility power system used in the driving unit 22 and the like in the present disclosure. The load device 16 can be, for example, a display system, an air conditioning system, a lighting system, a seat system, various devices, or the like installed on the mobility apparatus 10.

In some implementations, the mobility apparatus 10 can include an interface for receiving a request for movement control and the operation of the load device 16. The interface can be implemented as a hardware device, a software interface, or the like. The hardware interface is a hardware operating device for the movement operation that the user requests from the mobility apparatus 10 and can be, for example, an aircraft joystick, a ground steering wheel, ground pedals, buttons, a marine steering handler, or the like, but is not limited thereto. The software interface can be, for example, a touch-enabled display, but is not limited thereto.

In addition, the mobility apparatus 10 can include a power source unit 18, an operating unit 20, and a driving unit 22.

The power source unit 18 can generate and supply power and electric power used for a mobility power system, such as the driving unit 22, and the load device 16. The mobility apparatus 10 can generate energy by at least one of various energy sources. When the mobility apparatus 10 is driven based on electric energy, the power source unit 18 can be composed of, for example, an electric battery or a combination of the electric battery and a charging module for charging the battery. When the power source unit 18 is composed of only the electric battery, the electric battery can be charged from a charging station or another mobility apparatus to supply power. When the power source unit 18 is composed of a combination of the electric battery and the charging module, the power source unit 18 can adopt at least one of a fuel cell and a fossil energy-based engine as a charging module. The fuel cell can use a material used to produce electricity, such as hydrogen gas. When the power source unit 18 is an engine, the power source unit 18 has a generator coupled with the engine, and the generator can convert mechanical energy generated by the engine into electrical energy and charge the electric battery with the converted electrical energy.

As another example, when the mobility apparatus 10 is driven based on fossil energy or nuclear fuel, the power source unit 18 can be composed of an internal combustion engine, a turbine engine, a nuclear fuel-based engine, or the like. As still another example, the mobility apparatus 10 can have the power source unit 18 in a hybrid form of a fossil fuel-based engine and an electric battery. The hybrid power source unit 18 can charge the electric battery using an output of the engine generated during movement, select one of power of the engine or power of the electric battery depending on states of the mobility apparatus 10, attributes of the movement path, movement situations, or the like, and generate a movement driving force of the driving unit 22. As another example, the hybrid power source unit 18 can include an electric battery capable of being charged by an external source and an engine. The processor 26 can switch between the power of the engine and the power of the electric battery depending on various situations and states to apply energy to the driving unit 22, and thus the movement driving force can be generated.

The operating unit 20 and the driving unit 22 can form an actuating unit for transmitting power generated by the power source unit 18 to externally implement a predetermined movement motion. In the present disclosure, the actuating unit is referred to as an actuator, and these terms can be used interchangeably and described.

The operating unit 20 can have at least one module that implements a movement operation. When the mobility apparatus 10 is an air mobility apparatus, the operating unit 20 can have mechanical and software components for performing at least one operation among, for example, control of flight attitudes such as a roll, yaw, and pitch of the mobility apparatus 10, hovering control related to takeoff and landing, and flap control for a change in altitude and a turning operation. When the mobility apparatus 10 is a ground mobility apparatus, the operating unit 20 can have a mechanical and software component for implementing at least one driving operation among, for example, longitudinal control, such as acceleration and deceleration, and transverse control such as steering. The operating unit 20 of the ground mobility can include a module for transmitting power from the power source unit 18 to the driving unit 22 and a module for converting power transmitted to the driving unit into power having a predetermined size and form.

The driving unit 22 is a module for externally implementing linear movement, turning, acceleration/deceleration, attitude control, braking, hovering, or the like of the mobility apparatus 10 and can be implemented in various forms depending on the type of the mobility apparatus 10. When the mobility apparatus 10 is a typical mobility apparatus, the moving driving unit of the fixed-wing mobility apparatus can be a turbine engine, a flap, or the like that is installed on a main wing, a tail wing, and the like to implement the operation related to the thrust and lift of the mobility apparatus. As another example, the fixed-wing mobility device can further include a propulsion unit, such as a propeller, on a predetermined part of the main wing. The driving unit 22 of the typical rotary-wing mobility apparatus can be a rotor-type propulsion unit, flap, or the like that is installed on an upper portion of a fuselage and a tail wing. The typical mobility apparatus can have wheels, such as a landing gear for takeoff and landing, depending on the specifications, and the wheels can be accommodated in the fuselage during flight. The AAM type driving unit 22 can have a rotor type propulsion unit and flap similar to the rotary-wing mobility apparatus. A propulsion unit applied to the AAM type driving unit 22 can be fixed to at least the main wing to not tilt or installed on at least the main wing to tilt. As another example, the propulsion unit applied to the AAM type driving unit 22 can be installed as a plurality of propulsion units in the main wing. In addition, the AAM type driving unit 22 can be configured to rotate wings to which the propulsion unit is coupled within a predetermined angle range. The AAM type driving unit 22 can have wheels, such as a landing gear, which are accommodated in a fuselage during flight and are drawn out during takeoff and landing, depending on specifications. When the AAM type mobility apparatus is driven based on electric energy, the driving unit 22 can mainly include a motor and an inverter that use electric power to rotate the propeller. When the AAM type mobility apparatus is driven based on non-electric energy, such as fossil energy, the driving unit 22 can mainly be composed of modules for transmitting a rotational force generated by an internal combustion engine to the propeller.

When the mobility apparatus 10 is a ground mobility apparatus, the driving unit 22 can include a plurality of wheels, a driving force transmission module for generating a driving force to apply or transmit the driving force to wheels, a braking module for decelerating the driving of the wheels, a steering module for implementing transverse control of the wheels, and the like. The wheels, the driving force transmission module, the braking module, and the like can be formed as a driving assembly, and the driving assembly can be provided as a plurality of driving assemblies depending on the number of wheels.

When the mobility apparatus 10 is driven based on electric energy, the driving force transmission module can be formed as a motor module for generating a driving force based on power output from an electric battery.

In addition, the mobility apparatus 10 can include a memory 24 and the processor 26.

The memory 24 can store an application and various types of data for controlling the mobility apparatus 10 and load the application or read or write the data by the request of the processor 26. The application and data can vary depending on the type and specific specifications of the mobility apparatus 10 and include sensor data related to movement control, state data of the mobility related to movement control, data received from other devices, and data related to energy control between the power source unit 18 and the driving unit 22. In addition, the application and data can include data related to the control of a module in charge of a function other than the above control, software related to the operation of a computing system of a mobility, information and applications for autonomous movement, route information, various types of information and control programs for boarding convenience, and the like.

In relation to the present disclosure, the processor 26 can process movement control, route control, energy control, control of the load device 16, autonomous movement control, convenience function control, and the like using the application, instructions, and data that are stored in the memory 24. The processor 26 can also have different control processes depending on the type and specific specifications of the mobility apparatus 10. The processor 26 can be, for example, implemented as a single processing module. In another example, the processing according to the above matters can be processed in a distributed manner in a plurality of processing modules, and a plurality of processing modules in the present disclosure can be collectively referred to as the processor 26.

In the present disclosure, among various types of mobility apparatuses, the AAM type mobility apparatus is mainly described. Although the AAM type mobility apparatus is described, when the functions, modules, and devices of the mobility apparatus described in the present disclosure can be technically combined, they can be applied to other types of mobility apparatuses. In a broad sense, when the functions, modules, and devices of the mobility apparatus described in the present disclosure can be technically combined, they can be applied to mobility apparatuses for a ground, underground, space, sea, and underwater.

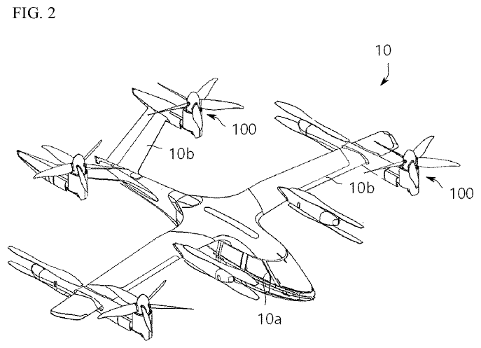

FIG. 2 is a view illustrating an example of a mobility apparatus.

In some implementations, the mobility apparatus 10 can include a streamlined fuselage 10a and wings 10b, such as a main wing and a tail wing, connected to the fuselage 10a. The fuselage 10a can have, for example, a cabin for a pilot and passengers and a space in which cargo is loaded.

A plurality of propulsion units can be disposed on the wings 10b, and each of the propulsion units 100 can include a propeller, a motor for rotating the propeller, an inverter for adjusting power of the power source unit 18 based on flight situations, motor specifications, or the like or converting a power form, and a cooling unit for cooling heat generated by the motor and the inverter. The propellers can be arranged parallel to the fuselage 10a.

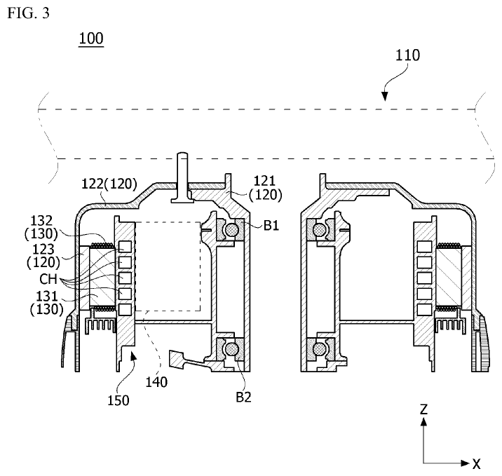

FIG. 3 is a side cross-sectional view illustrating the propulsion unit 100 of the mobility apparatus.

Referring to FIG. 3, in some implementations, the propulsion unit 100 of the mobility apparatus can include a propeller 110, a rotor 120, a stator 130, an inverter 140, and a cooling housing 150. Hereinafter, an axial direction of the propulsion unit 100 is a longitudinal direction of a shaft 121, and a radial direction is a direction perpendicular to the axial direction. Hereinafter, in the drawing, a z-axis refers to the axial direction, and an x-axis refers to the radial direction.

The propeller 110 is coupled with the shaft 121 of the rotor 120, and when the rotor 120 rotates, the propeller 110 also rotates and generates lift.

The rotor 120 can include the shaft 121, a yoke 122, and a magnet 123. The yoke 122 can be a cylindrical member having one open side in the axial direction. The shaft 121 can be coupled to an upper portion of the yoke 122. In addition, the magnet 123 can be fixed to an inner surface of a side portion of the yoke 122. The magnet 123 can be formed by combining a plurality of split magnets or can be a single ring-shaped magnet.

The stator 130 can be fixed to the cooling housing 150. The stator 130 is positioned to face the rotor 120. The stator 130 can be positioned radially inside the rotor 120. That is, the rotor 120 can be disposed outside the stator 130. Here, the term “inward” refers to a direction toward the shaft 121 based on the radial direction, and the term “outward” refers to a direction away from the shaft 121 based on the radial direction.

The stator 130 can include a stator core 131 and a coil 132 wound around the stator core 131.

The inverter 140 can be fixed to the cooling housing 150. In addition, the inverter 140 can be positioned inside the stator 130. That is, the inverter 140 can be disposed to overlap the stator 130 in the radial direction. The inverter 140 can be disposed closer to an axial center of the propeller 110 than the stator 130 in the radial direction. In this way, since the inverter 140 is disposed between the stator 130 and the shaft 121 in the radial direction, it is possible to greatly reduce the size of the propulsion unit 100 in the axial direction.

The cooling housing 150 is disposed outside the shaft 121. In addition, the cooling housing 150 is positioned inside the stator 130. The cooling housing 150 can include a plurality of cooling channels CH. The cooling channels CH can be positioned between the stator 130 and the inverter 140 in the radial direction. The cooling housing 150 is fixed to not rotate unlike the shaft 121. Bearings B1 and B2 can be fixed to the cooling housing 150. The bearings B1 and B2 rotatably support the shaft 121. The bearings B1 and B2 can include an upper bearing B1 and a lower bearing B2. The upper bearing B1 can be disposed on an upper portion of the cooling housing 150, and the lower bearing B2 can be disposed on a lower portion of the cooling housing 150.

The inverter 140 is positioned adjacent to the motor with the cooling housing 150 interposed therebetween in the radial direction. Since the inverter 140 is positioned inside the motor in the radial direction, a size of the propulsion unit 100 can be greatly reduced in the axial direction. In addition, since the cooling housing 150 is positioned between the inverter 140 and the motor in the radial direction so that the motor and the inverter 140 share the cooling housing 150, it may not be necessary to provide a separate cooling unit for cooling the inverter 140, and thus a configuration can be simple and the size of the propulsion unit 100 can be reduced.

Specifically, in some examples, since various components such as wires for connecting the motor to the inverter 140 may be omitted, the assembly structure can be simplified, an operating system of the propulsion unit can be simplified, and the degree of freedom in designing other components can be increased.

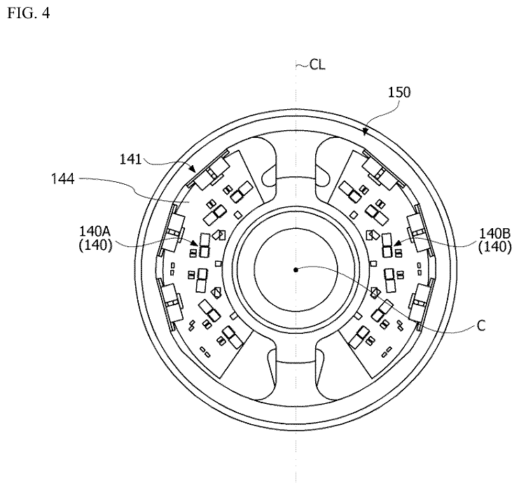

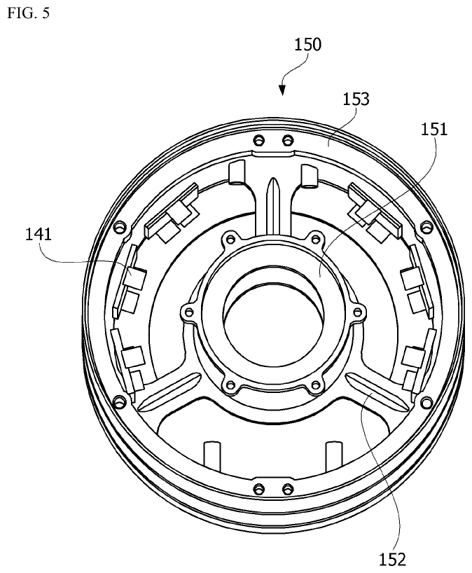

FIG. 4 is a view illustrating the cooling housing 150, and FIG. 5 is a view illustrating the cooling housing 150 in which the inverter 140 is disposed.

Referring to FIGS. 4 and 5, the cooling housing 150 can include a cylindrical hub 151, arm portions 152 extending radially from the hub 151, and a rim portion 153 connected to the arm portions 152. The cooling channels CH can be formed inside the rim portion 153. The cooling channel CH is a space in which a coolant flows into an empty space of the cooling housing 150 formed along the rim portion 153. The cooling channel CH can be provided as a plurality of cooling channels.

The stator 130 is fixed in contact with an outer circumferential surface of the rim portion 153. The inverter 140 can be positioned inside the rim portion 153. Among components of the inverter 140, an element 141 that generates heat can be fixed to the rim portion 153 in direct contact with an inner circumferential surface of the rim portion 153.

As illustrated in FIG. 5, the inverter 140 can be positioned between the rim portion 153 and the hub 151 in the radial direction and fixed to the cooling housing 150. Since the inverter 140 is disposed directly adjacent to the rim portion 153 having the cooling channel CH, heat generated by the inverter 140 can be effectively exchanged with the coolant flowing in the cooling channels CH. The element 141 in direct contact with the cooling housing 150 can be a silicon carbide power module (or circuit).

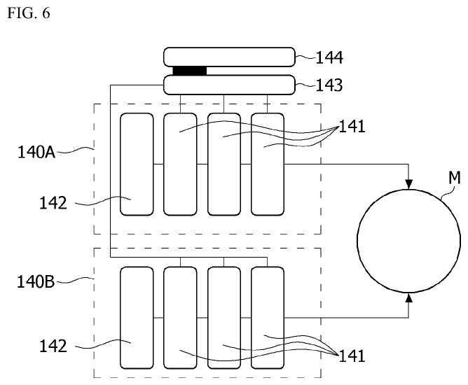

FIG. 6 is a view illustrating a first inverter 140A and a second inverter 140B.

Referring to FIGS. 4 and 6, the inverter 140 can include the first inverter 140A and the second inverter 140B.

The first inverter 140A and the second inverter 140B can have separate circuits and be configured to operate independently. When one of the first inverter 140A or the second inverter 140B fails, electric power can be supplied to a motor M through the other one of the first inverter 140A or the second inverter 140B that is not failed.

The first inverter 140A can include a control board 144, a gate board 143 electrically connected to the control board 144, and a capacitor board 142 electrically connected to the control board 144 and the gate board 143. The gate board 143 can be connected to the elements 141 of the first inverter 140A. The element 141 can be an electrical circuit or a substrate having the electrical circuit. For example, the element 141 can be a silicon carbide (SiC) power module (or circuit).

The second inverter 140B can also include the control board 144, the gate board 143 electrically connected to the control board 144, and the capacitor board 142 electrically connected to the control board 144 and the gate board 143. The gate board 143 can be connected to the elements 141 of the second inverter 140B. The element 141 can be a silicon carbide (SiC) power module.

In an axial view, the first inverter 140A can be disposed on one side of a reference line CL passing through an axis center, and the second inverter 140B can be disposed on the other side of the reference line CL. The first inverter 140A and the second inverter 140B can be disposed symmetrically with respect to the reference line CL.

The element 141 of the first inverter 140A can be disposed on one side of the reference line CL, and the element 141 of the second inverter 140B can be disposed on the other side of the reference line CL. A plurality of elements 141 can be disposed. The plurality of elements 141 can each be fixed to an inner surface of the cooling housing 150. For example, the elements 141 of the first inverter 140A can be provided as three elements, and the three elements 141 can be disposed at regular intervals in a circumferential direction of the cooling housing 150 on the inner surface of the cooling housing 150. The elements 141 of the second inverter 140B can also be provided as three elements, and the three elements 141 can be disposed at regular intervals in the circumferential direction of the cooling housing 150 on the inner surface of the cooling housing 150.

The elements 141 of the first inverter 140A and the elements 141 of the second inverter 140B can be disposed symmetrically with respect to the reference line CL.

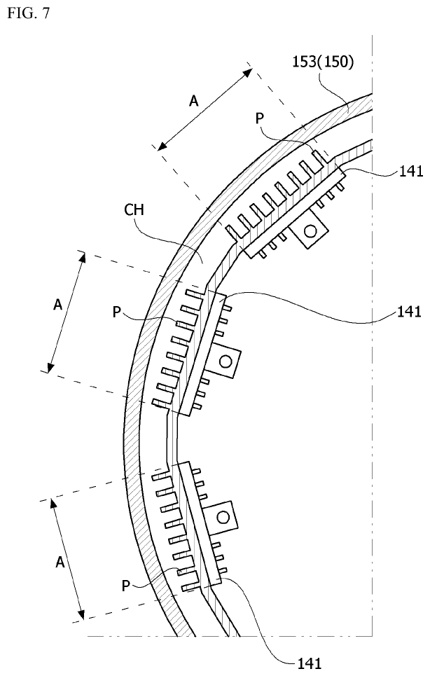

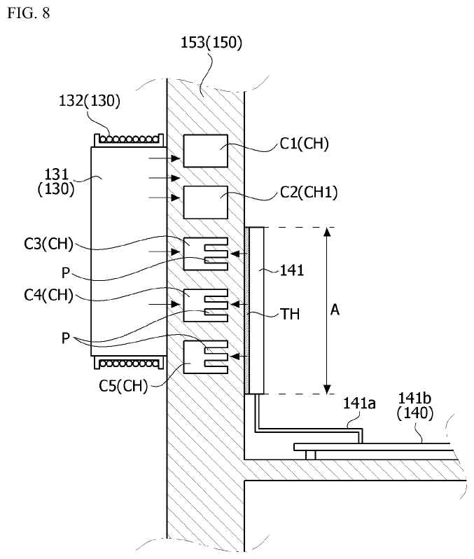

FIG. 7 is a plan view illustrating the elements 141 fixed to the cooling housing 150, and FIG. 8 is a side cross-sectional view illustrating the elements 141 fixed to the cooling housing 150.

Referring to FIGS. 7 and 8, the elements 141 can be fixed in contact with an inner surface of the rim portion 153 of the cooling housing 150. In the axial direction, the elements 141 can be positioned to be spaced apart from a board 141b of the inverter 140. The elements 141 and the board 141b can be connected through a separate connection terminal 141a. In the radial direction, the elements 141 can be positioned to overlap the cooling channel CH.

Heat generated by the elements 141 can be transferred to the cooling housing 150 and dissipated through heat exchange with the coolant flowing in the cooling channel CH. In this way, since the elements 141 are in direct contact with the cooling housing 150 and is positioned as close as possible to the cooling channel CH, heat generated by the elements 141 can be effectively dissipated.

The cooling channel CH can be formed to form a plurality of rows in the axial direction. For example, the cooling channel CH can include a first channel C1, a second channel C2, a third channel C3, a fourth channel C4, and a fifth channel C5 that form five rows. In the axial direction, a part of the cooling channel CH positioned at an uppermost position in the drawing is the first channel C1, a part of the cooling channel CH positioned at a lowermost position in the drawing is the fifth channel C5, and the second channel C2, the third channel C3, and the fourth channel C4 can be positioned between the first channel C1 and the fifth channel C5.

An outer side of the cooling housing 150 including the cooling channel CH is in contact with the stator 130, and an inner side thereof is in contact with the elements 141 of the inverter 140. The cooling channel CH is positioned to overlap the stator 130 in the radial direction. In addition, the cooling channel CH is positioned to overlap the elements 141 of the inverter 140 in the radial direction.

Heat generated by the stator 130 is transferred to the cooling channel CH of the cooling housing 150, and heat generated by the elements 141 is also transferred to the cooling channel CH of the cooling housing 150. In this way, heat transferred from the outside and inside of the cooling housing 150 to the cooling channel CH is heat-exchanged with the coolant flowing in the cooling channel CH.

In some implementations, the cooling channel CH can include a fin P therein, and the fin P can protrude from an inner wall of the cooling channel CH to the inside of the cooling channel CH. For example, the cooling channel CH can include an inner wall and an outer wall that face each other in the radial direction, and the fin P can protrude from the inner wall toward the outer wall.

The fin P can be provided as a plurality of fins. The plurality of fins P can be disposed at regular intervals. All the plurality of fins P can form a group, and the group can be positioned to correspond to a first region A of the cooling housing 150. Here, the first region A is a part of the cooling housing 150 in contact with the element 141 of the inverter.

As illustrated in FIG. 7, the plurality of elements 141 are in contact with the inner surface of the cooling housing at regular intervals in the circumferential direction. In addition, the fins P are positioned inside the cooling channel CH corresponding to the first region A in contact with the element 141. As illustrated in FIG. 8, the first region A in contact with the element 141 can correspond to some of a plurality of rows forming the cooling channel CH. For example, the first region A can correspond to some of the five channels, that is, the third channel, the fourth channel C4, and the fifth channel C5. In addition, the fin P can be positioned in each of the third channel C3, the fourth channel C4, and the fifth channel C5 that correspond to the first region A.

The plurality of fins P can be disposed apart from each other in the circumferential direction. In addition, the plurality of fins P can be disposed apart from each other in the axial direction.

In some implementations, a heat transfer pad TH can be disposed between the rim portion 153 of the cooling housing 150 and the element 141. The heat transfer pad TH serves to transfer heat generated by the element 141 to the cooling housing 150.

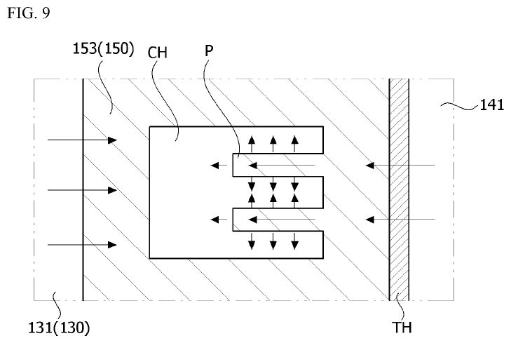

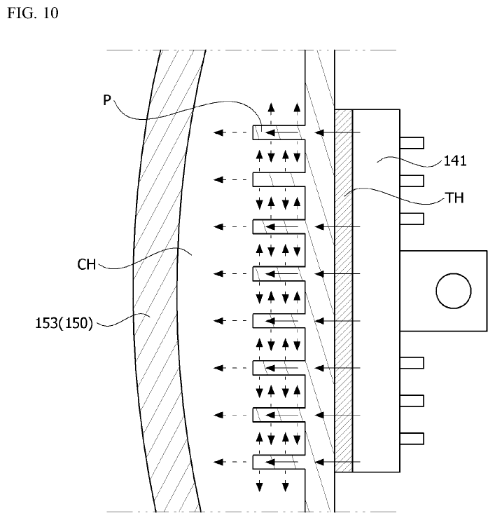

FIG. 9 is a cross-sectional view illustrating a process of dissipating heat through the fins P, and FIG. 10 is a plan cross-sectional view illustrating the process of dissipating heat through the fins P.

Referring to FIGS. 9 and 10, heat generated by the element 141 is transferred to the cooling housing 150 through the heat transfer pad TH. The heat transferred to the cooling housing 150 is transferred to the fins P. The heat transferred to the fins P is transferred to the coolant near the fins P. The fin P can quickly and effectively dissipate the heat transferred to the cooling housing 150 because the fins P increase an contact area with the coolant in the cooling channel CH.

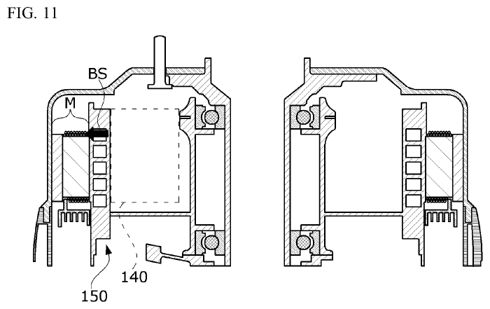

FIG. 11 is a cross-sectional view illustrating positions of the inverter 140 and the motor M.

Since the motor M is positioned directly adjacent to the inverter 140 with the cooling housing 150 interposed therebetween in the radial direction, there is an advantage in that a path of a busbar BS connecting the motor M to the inverter 140 is shortened. This helps simplify a configuration of the busbar BS and reduce the size and weight of the propulsion unit 100.

In some implementations, it is possible to reduce a size of a propulsion unit by arranging an inverter between a shaft and a stator.

In some implementations, since the inverter is disposed adjacent to the stator in a radial direction, it is possible to greatly reduce a connection path between a motor and the inverter.

In some implementations, since a cooling channel is positioned between the stator and the inverter in the radial direction perpendicular to an axial direction and is adjacent to both the stator and the inverter, it is possible to increase a heat dissipation effect.

In some implementations, since the cooling channel is positioned between the stator and the inverter in the radial direction perpendicular to the axial direction, it is possible to reduce a distance between the stator and the inverter and reduce an overall size and weight of a propulsion unit.

In some implementations, a component of the inverter, which generates much heat, is in direct contact with the cooling housing, thereby increasing the cooling efficiency of the inverter.

In some implementations, fins are formed on the cooling channel, thereby increasing the cooling efficiency of the inverter.

In some implementations, the component of the inverter, which generates much heat, is in direct contact with the cooling housing, and the fins are disposed to correspond to such contact region, thereby increasing the cooling efficiency of the inverter.

Although the present disclosure has been described above with reference to example implementations, those skilled in the art will understand that the present disclosure can be modified and changed variously without departing from the spirit and scope of the present disclosure as described in the appended claims.

What is claimed is:

1. A propulsion unit comprising:
a stator;
a rotor configured to rotate relative to the stator;
an inverter electrically connected to the stator; and
a cooling housing that is in contact with the stator and the inverter and configured to carry coolant therein.

2. The propulsion unit of claim 1, wherein the cooling housing has an outer surface and an inner surface,
wherein the inverter is in contact with one of the outer surface or the inner surface of the cooling housing, and
wherein the stator is in contact with the other of the outer surface or the inner surface of the cooling housing.

3. The propulsion unit of claim 1, wherein the inverter is positioned between a shaft of the rotor and the stator in a radial direction of the rotor, and
wherein the cooling housing is positioned between the stator and the inverter in the radial direction.

4. The propulsion unit of claim 1, wherein the cooling housing defines a cooling channel configured to carry the coolant, the cooling channel being positioned adjacent to the stator and the inverter.

5. The propulsion unit of claim 4, wherein the cooling housing comprises a plurality of fins that protrude from an inner wall of the cooling channel.

6. The propulsion unit of claim 5, wherein the plurality of fins are disposed at each of a plurality of first regions of the cooling channel, the plurality of first regions being spaced apart from one another in a circumferential direction of the cooling housing.

7. The propulsion unit of claim 6, wherein the inverter has at least one element that is in contact with the cooling housing.

8. The propulsion unit of claim 7, wherein the at least one element of the inverter is in contact with a part of the cooling housing corresponding to one of the plurality of first regions.

9. The propulsion unit of claim 6, wherein the cooling channel is arranged in a plurality of rows that extend in an axial direction, and
wherein the plurality of fins are disposed in at least two of the plurality of rows of the cooling channel.

10. The propulsion unit of claim 5, wherein the cooling channel has the inner wall and an outer wall that face each other in a radial direction of the cooling housing, and
wherein the plurality of fins protrude from the inner wall toward the outer wall.

11. The propulsion unit of claim 4, wherein the cooling housing comprises:
a hub;
a rim portion disposed outside the hub; and
an arm portion connecting the hub to the rim portion, and
wherein the cooling channel is disposed at the rim portion.

12. The propulsion unit of claim 11, wherein the inverter comprises a board and an element electrically connected to the board, the element having (i) a first side that is in contact with the rim portion and (ii) a second side connected to the board of the inverter.

13. The propulsion unit of claim 11, wherein the inverter comprises at least one element fixed to an inner surface of the rim portion.

14. The propulsion unit of claim 11, further comprising a heat transfer pad disposed between an element of the inverter and the cooling housing and configured to transfer heat generated from the element to the cooling housing.

15. The propulsion unit of claim 11, wherein the inverter comprises a substrate, an element spaced apart from the substrate, and a connection terminal that connects the element to the substrate.

16. The propulsion unit of claim 11, wherein the inverter comprises an element that overlaps the cooling channel in a radial direction of the cooling housing.

17. The propulsion unit of claim 1, wherein the inverter is one of a first inverter and a second inverter that are electrically separated from each other and configured to operate independently.

18. The propulsion unit of claim 17, wherein each of the first inverter and the second inverter comprises at least one element in contact with the cooling housing.

19. The propulsion unit of claim 18, wherein the first inverter and the second inverter are disposed symmetrically with respect to a reference line passing through a rotation center axis of the rotor, the first inverter being disposed at a first side of the reference line, and the second inverter being disposed at a second side of the reference line.

20. The propulsion unit of claim 7, wherein the at least one element of the inverter comprises a silicon carbide (SiC) power circuit.
